(19) United States
(12) Patent Application Publication
(10) Pub. No.: US 2026/0040234 A1
(43) Pub. Date: Feb. 5, 2026

(54) CONFIGURATION AND TRANSMISSION OF POWER REPORTS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 19/253,691

(22) Filed: Jun. 27, 2025

Related U.S. Application Data
(60) Provisional application No. 63/678,266, filed on Aug. 1, 2024.

(51) Int. Cl. H04W 52/36; H04W 52/24

(52) U.S. Cl. CPC H04W 52/365; H04W 52/245

(57) ABSTRACT

Apparatuses and methods for configuration and transmission of power reports. A method for a user equipment (UE) includes receiving first information for a set of candidate cells and receiving second information for a set of reference signals (RSs). One or more RSs from the set of RSs are associated with one candidate cell from the set of candidate cells. A RS for a candidate cell is identified by a corresponding RS index. The method further includes receiving a first and second RSs from a first candidate cell and a serving cell, respectively, determining a first and second reference signal received powers (RSRPs) for the first and second RSs, respectively, determining a first and second power headroom reports (PHRs) that are associated with respective transmissions on the first candidate cell and the serving cell, and transmitting a channel with the first and second RSRPs and the first and second PHRs.

### CROSS-REFERENCE TO RELATED AND CLAIM OF PRIORITY

The present application claims priority under 35 U.S.C. § 119(e) to U.S. Provisional Patent Application No. 63/678,266 filed on Aug. 1, 2024, which is hereby incorporated by reference in its entirety.

### TECHNICAL FIELD

The present disclosure relates generally to wireless communication systems and, more specifically, the present disclosure is related to apparatuses and methods for configuration and transmission of power reports.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to configuration and transmission of power reports.

In one embodiment, a method for a user equipment (UE) is provided. The method includes receiving first information for a set of candidate cells and receiving second information for a set of reference signals (RSs) Each candidate cell from the set of candidate cells is identified by a corresponding candidate cell index. One or more RSs from the set of RSs are associated with one candidate cell from the set of candidate cells. A RS for a candidate cell is identified by a corresponding RS index. The method further includes receiving a first RS from a first candidate cell, receiving a second RS from a serving cell, determining a first reference signal received power (RSRP) for the first RS, and determining a second RSRP for the second RS. The method further includes determining a first power headroom report (PHR) that is associated with a transmission on the first candidate cell, determining a second PHR that is associated with a transmission on the serving cell, and transmitting a channel with the first RSRP, the second RSRP, the first PHR, and the second PHR.

In another embodiment, a UE is provided. The UE includes a transceiver configured to receive first information for a set of candidate cells and second information for a set of RSs. One or more RSs from the set of RSs are associated with one candidate cell from the set of candidate cells. A RS for a candidate cell is identified by a corresponding RS index. The transceiver is further configured to receive a first RS from a first candidate cell and a second RS from a serving cell. The UE further includes a processor operably coupled to the transceiver. The processor is configured to determine a first RSRP for the first RS, a second RSRP for the second RS, a first PHR that is associated with a transmission on the first candidate cell, and a second PHR that is associated with a transmission on the serving cell. The transceiver is further configured to transmit a channel with the first RSRP, the second RSRP, the first PHR, and the second PHR.

In yet another embodiment, a base station (BS) is provided. The BS includes a transceiver configured to transmit first information for a set of candidate cells and second information for a set of RSs. Each candidate cell from the set of candidate cells is identified by a corresponding candidate cell index. One or more RSs from the set of RSs are associated with one candidate cell from the set of candidate cells. A RS for a candidate cell is identified by a corresponding RS index. The transceiver is further configured to transmit a first RS from a first candidate cell and a second RS from a serving cell and receive a channel with a first RSRP, a second RSRP, a first PHR, and a second PHR. The BS further includes a processor operably coupled to the transceiver. The processor is configured to determine an index of a candidate cell associated with the first RSRP and an index of an RS associated with the first RSRP and with the first PHR.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a signal flow of an example procedure for a conditional handover (CHO) according to embodiments of the present disclosure;

FIG. 7 illustrates a flowchart of an example UE procedure for transmitting power headroom reports (PHRs) according to embodiments of the present disclosure;

FIG. 8 illustrates timelines for transmit power estimation and power level support according to embodiments of the present disclosure;

FIGS. 9A and 9B illustrate diagrams of example of medium access control (MAC) control elements (CEs) according to embodiments of the present disclosure;

FIGS. 10A and 10B illustrate diagrams of example of MAC CEs according to embodiments of the present disclosure;

FIG. 11 illustrates a diagram of an example MAC CE according to embodiments of the present disclosure;

FIG. 12 illustrates a diagram of an example MAC CE according to embodiments of the present disclosure;

FIG. 13 illustrates a flowchart of an example UE procedure for transmitting an energy report and receiving a handover (HO) command according to embodiments of the present disclosure;

FIG. 14 illustrates a flowchart of an example UE procedure for transmitting an energy report according to embodiments of the present disclosure;

FIG. 15 illustrates a flowchart of an example UE procedure for receiving a HO command according to embodiments of the present disclosure; and

FIG. 16 illustrates a flowchart of an example UE procedure for providing an energy report associated with a beam according to embodiments of the present disclosure.

### DETAILED DESCRIPTION

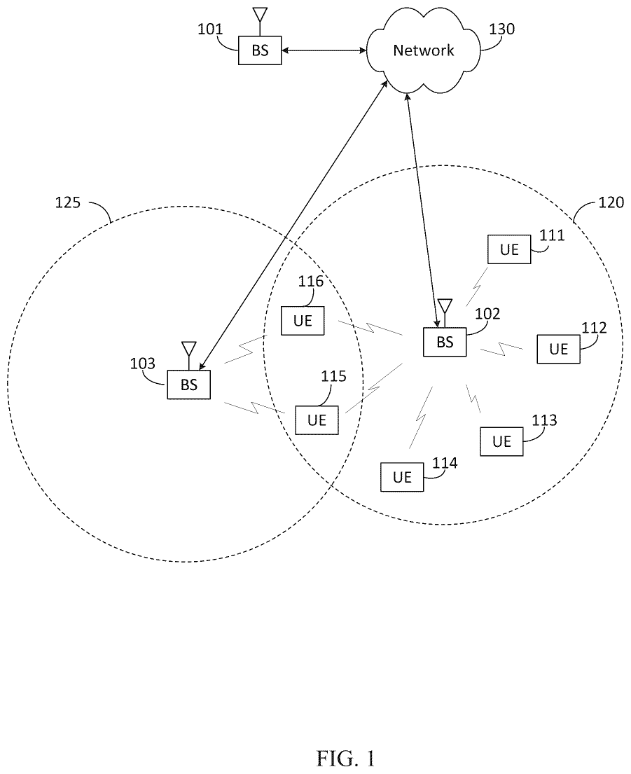

FIGS. 1-16 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein:

[REF 1] 3GPP TS 38.101-1 v18.5.0: “NR; User Equipment (UE) radio transmission and reception; Part 1: Range 1 Standalone;” [REF 2] 3GPP TS 38.101-2 v18.5.0: “NR; User Equipment (UE) radio transmission and reception; Part 2: Range 2 Standalone;” [REF 3] 3GPP TS 38.101-3 v18.5.1: “NR; User Equipment (UE) radio transmission and reception; Part 3: Range 1 and Range 2 Interworking operation with other radios;” [REF 4] 3GPP TS 38.211 v18.2.0, “NR; Physical channels and modulation;” [REF 5] 3GPP TS 38.212 v18.2.0, “NR; Multiplexing and channel coding;” [REF 6] 3GPP TS 38.213 v18.2.0, “NR; Physical layer procedures for control;” [REF 7] 3GPP TS 38.214 v18.2.0, “NR; Physical layer procedures for data;” [REF 8] 3GPP TS 38.321 v18.1.0, “NR; Medium Access Control (MAC) Protocol Specification;” and [REF 9] 3GPP TS 38.331 v18.1.0, “NR; Radio Resource Control (RRC) Protocol Specification.”

FIGS. 1-23 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing a configuration for and performing a transmission of power reports. In certain embodiments, one or more of the BSs 101-103 include circuitry, programing, or a combination thereof to support configuration and transmission of power reports.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

Throughout this disclosure the terms satellite or serving gNB are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms, as well as to terrestrial networks.

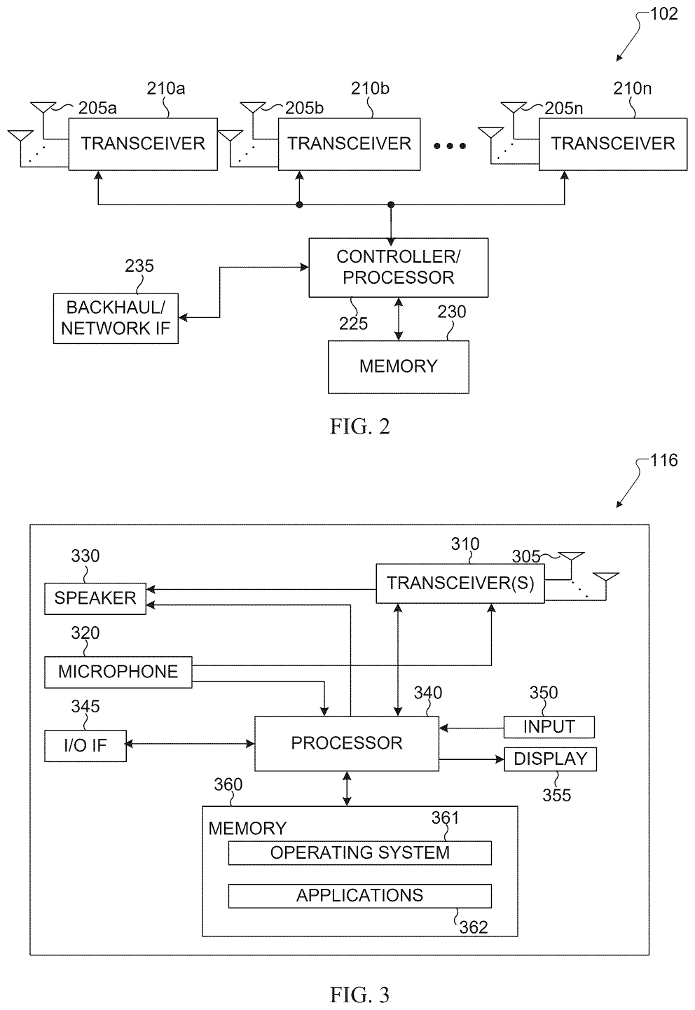

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for configuration and transmission of power reports. Any of a wide variety of other functions could be supported in the gNB 102 by the controller/processor 225.

The controller/processor 225 is also capable of executing programs and other processes resident in the memory 230, such as processes to support configuration and transmission of power reports. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing a configuration for and performing a transmission of power reports as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

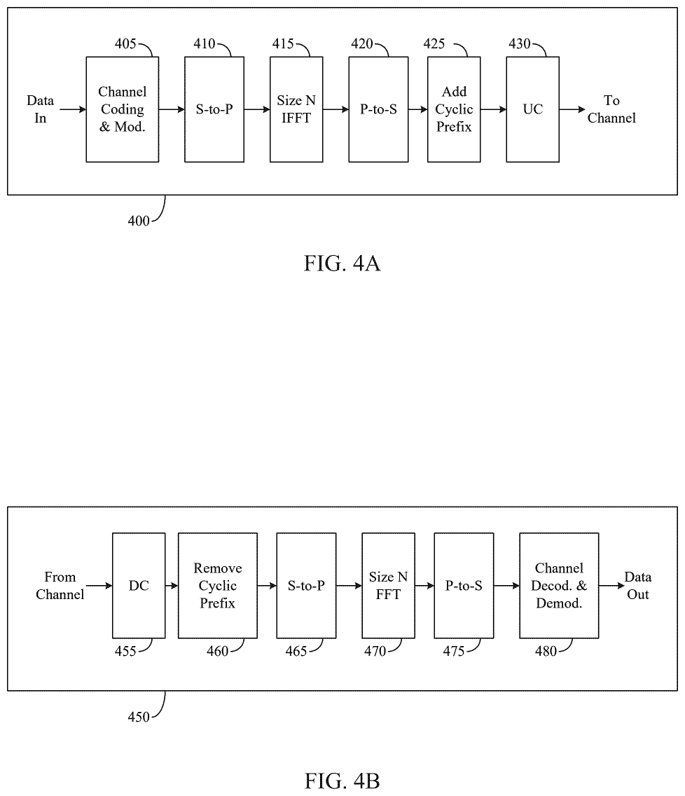

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for transmission of power reports as described in embodiments of the present disclosure. In some embodiments, the receive path 450 is configured for reception of power reports as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

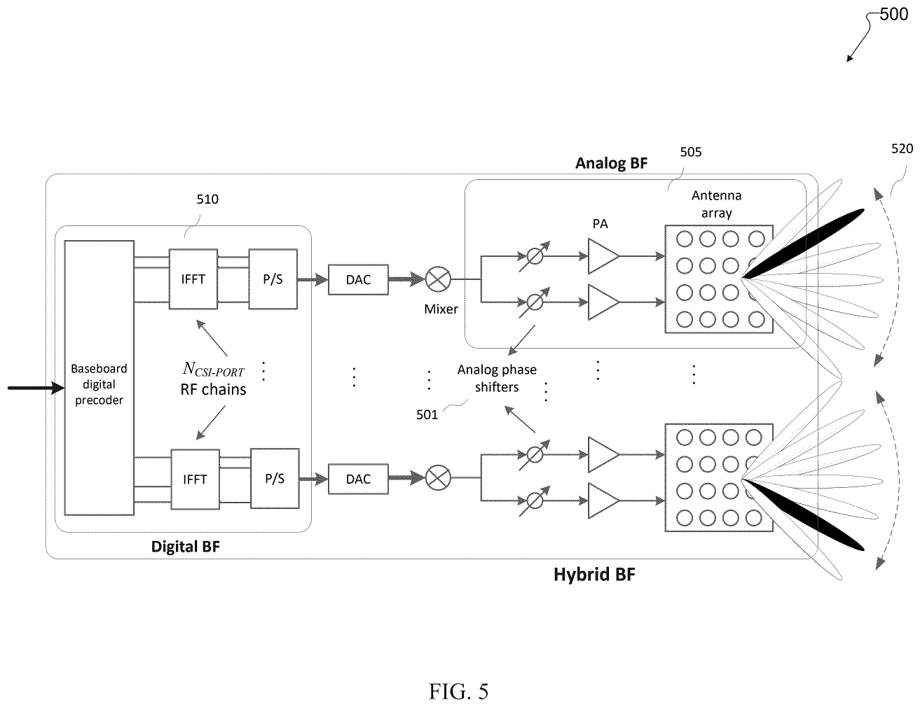

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path-loss.

A reporting configuration can be associated with reporting quantities or measurements that are related to a UE transmit power and its capability of transmitting with a certain power over a certain period of time in a cell using a beam, and the quantities can be provided via RRC signalling, MAC CE or a downlink control information (DCI) format. Quantities or measurements in one or multiple cells can be used by a gNB to prepare a HO procedure and trigger a HO command and/or to determine a new beam (or transmission configuration indication (TCI)-state) and indicate the new beam to the UE. The HO command in an RRC message can also include the information of the new beam that can be used by the UE for the initial transmission in a target cell. Therefore, embodiments of the present disclosure recognize that there is a need to determine the quantities that are related to a UE transmit power. Embodiments of the present disclosure further recognize that there is another need to define procedure for HO based on the determined quantities. Embodiments of the present disclosure further recognize that there is also another need to define the signalling for providing the determined quantities.

The following descriptions and embodiments directly apply or are adaptable to terrestrial networks (TN) and non-terrestrial networks (NTN), and functionalities of a satellite and/or of a satellite gateway on earth that is connected to the satellite in NTN can be same as the functionalities of a serving gNB in TN, or can be adapted taking also into account that the satellite footprint of a Low Earth Orbit (LEO) satellite moves over time because of the movement of the satellite respect to the earth. For a Geostationary Earth Orbiting (GEO) satellite, the satellite footprint is fixed, similar to a coverage area of a cell by the gNB in TN.

A power headroom report (PHR) provides support to a gNB for power control of uplink transmissions. There are three types of PHRs: a first one for physical uplink shared channel (PUSCH) transmission, a second one for PUSCH and physical uplink control channel (PUCCH) transmission in an LTE Cell Group in EN-DC (in TS 37.340), and a third one for sounding reference signal (SRS) transmission on SCells configured with SRS only. Type 1 power headroom is the difference between the nominal UE maximum transmit power and the estimated power for UL-SCH/PUSCH transmission per activated Serving Cell. Type 2 power headroom is the difference between the nominal UE maximum transmit power and the estimated power for UL-SCH/PUSCH and PUCCH transmission on SpCell of the other MAC entity (i.e. E-UTRA MAC entity in EN-DC, NE-DC, and NGEN-DC cases). Type 3 power headroom is the difference between the nominal UE maximum transmit power and the estimated power for SRS transmission per activated Serving Cell.

In case of CA, when there is no transmission on an activated SCell, a power for a reference/virtual transmission is used to provide a virtual PHR. To allow a network to detect a reduction in transmission power by a UE, PHR reports may also contain Power Management Maximum Power Reduction (P-MPR, in TS 38.101-2) information that the UE uses to ensure compliance with the Maximum Permissible Exposure (MPE) exposure regulation for FR2 for limiting RF exposure on human body. MPE P-MPR is defined as the power back-off to meet the MPE FR2 requirements for a Serving Cell operating on FR2.

A UE provides PHR using a MAC control element (CE). A PHR can be triggered by any of the following events:
A timer expires.
A timer expires or has expired, and a path-loss/reference signal received power (RSRP) has changed more than a configured value for at least one RS used as path-loss/RSRP reference for one activated Serving Cell of any MAC entity of which the active DL bandwidth part (BWP) is not dormant BWP since the last transmission of a PHR in this MAC entity when the MAC entity has UL resources for new transmission. The path-loss variation for one cell assessed herein is between the path-loss measured at present time on the current path-loss reference and the path-loss measured at the transmission time of the last transmission of PHR on the path-loss reference in use at that time, irrespective of whether the path-loss reference has changed in between. A UE can determine a path-loss from an RSRP measurement.
Configuration or reconfiguration of the power headroom reporting functionality by upper layers, when the PHR function is enabled.
Activation of an SCell of any MAC entity with configured uplink corresponding to a DL BWP that is not set to dormant BWP.
Activation of a secondary cell group (SCG).
Addition of the primary secondary cell (PSCell) except if the SCG is deactivated (i.e. PSCell is newly added or changed).
A timer expires or has expired, when the MAC entity has UL resources for new transmission, and for any of the activated Serving Cells of any MAC entity with configured uplink, there are UL resources allocated for transmission or there is a PUCCH transmission on that cell, and the required power backoff due to power management (as allowed by P-MPR_{c} as specified in TS 38.101-1, TS 38.101-2, and TS 38.101-3) for that cell has changed more than a configured value since the last transmission of a PHR when the MAC entity had UL resources allocated for transmission or PUCCH transmission on that cell.
Switching of activated BWP from dormant BWP to non-dormant DL BWP of an SCell of any MAC entity with configured uplink.
When MPE reporting is configured and a corresponding MPE timer is not running: the measured P-MPR applied to meet FR2 MPE requirements as specified in TS 38.101-2 is equal to or larger than a threshold for at least one activated FR2 Serving Cell since the last transmission of a PHR in this MAC entity; or the measured P-MPR applied to meet FR2 MPE requirements as specified in TS 38.101-2 has changed more than a configured value for at least one activated FR2 Serving Cell since the last transmission of a PHR due to the measured P-MPR applied to meet MPE requirements being equal to or larger than a threshold in this MAC entity. In this case the PHR is referred to as ‘MPE P-MPR report’. Triggering a PHR when the required power backoff due to power management decreases only temporarily (e.g. for up to a few tens of milliseconds) should be avoided so that such temporary decrease is not reflected in the values of P_{CMAX,f,c}/PH when a PHR is triggered by other triggering conditions.

A UE sets its configured maximum output power P_{CMAX,f,c} for carrier f of serving cell c in each slot between an upper limit and a lower limit as follows:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} ,$$

$$and$$

$${P}_{CMAX \_ H , f , c} = MIN \{ {P}_{EMAX , c} , {P}_{PowerClass} - Δ {P}_{PowerClass} \} ,$$

where P_{EMAX,c} is provided by higher layer parameters and depends on UE capability of using power boosting with a modulation, for example Pi/2 BPSK modulation, in certain bands for a number of slots of a radio frame, P_{PowerClass} is the maximum UE power specified specified in Table 6.2.1-1 of TS 38.101-1 v18.5.0 per power class without taking into account tolerances defined per band or band combinations or reported by the UE, and ΔP_{PowerClass} indicates a value (3 dB or 0 dB) depending on a UE capability of supporting a maximum duty cycle defined for the UE larger power class, if present, and on a percentage of uplink symbols transmitted in a certain evaluation period being larger than 25% or 50%. The maximum duty cycle is indicated for a UE power class and indicates the maximum percentage of uplink symbols that can be transmitted in a certain evaluation period using the indicated power class in order to meet specific absorption requirements (SAR) requirements. For example, the maximum duty cycle can be indicated for PC2, for example by maxUplinkDutyCycle-PC2-FR1, or for PC1.5, for example by maxUplinkDutyCycle-PC1dot5-MPE-FR1. Additional power tolerances are ΔT_{IB,c}, ΔT_{C,c}, or ΔT_{RxSRS}, which are specified in TS 38.101-1 clause 6.2A.4.2 for NR CA, TS 38.101-1 in clause 6.2C.2 for supplementary uplink (SUL), or TS 38.101-3 clause 6.2B.4.2 for EN-DC, and are related to operation with CA, SUL or DC, in certain band or band combination, or to SRS transmission. For the UE capability of supporting a maximum duty cycle, the UE may indicate a maximum percentage of uplink symbols transmitted in a certain evaluation period using the transmit power of the UE power class to meet specific absorption requirements (SAR) requirements.

MPR_{c} and A-MPR_{c} for serving cell c, are related to a UE reducing a maximum output power due to higher order modulation and transmit bandwidth configurations, or due to additional emission requirements signaled by the network, respectively. An additional emission requirement is associated with a unique network signalling (NS) value indicated in RRC signalling by an NR frequency band number of the applicable operating band and by an associated value, in corresponding RRC information elements. To meet the additional requirements, additional maximum power reduction (A-MPR) is allowed for the maximum output power and, unless specified otherwise, the total reduction to UE maximum output power is the maximum of MPR and A-MPR, i.e. max(MPR, A-MPR).

MPR values are specified based on the resource block (RB) allocation. For example, there is a set of MPR values for SRS, PUCCH formats 0, 1, 3 and 4, and physical random access channel (PRACH) are specified for QPSK modulated DFT-s-OFDM of equivalent RB allocation, and another set of MPR values for PUCCH format 2 are specified for QPSK modulated cyclic prefix (CP)-OFDM of equivalent RB allocation. For RB allocations, N_{RB} is the maximum number of RBs for a given channel bandwidth and sub-carrier spacing, where max( ) indicates the largest value of arguments and floor(x) is the greatest integer that is smaller than or equal to x, RB_{Start,Low}=max(1, floor(L_{CRB}/2)), and RB_{Start,High}=N_{RB}−RB_{Start,Low}−L_{CRB}. The RB allocation is an Inner RB allocation if the following conditions are met: RB_{Start,Low}≤RB_{Start}≤RB_{Start,High}, and L_{CRB}≤ceil(N_{RB}/2) where ceil(x) is the smallest integer that is larger than or equal to x. For pi/2 binary phase-shift keying (BPSK) modulation, an RB allocation is an Edge RB allocation if RB(s) is (are) allocated at the lowermost or uppermost edge of the channel and L_{CRB}≤2 RBs. The RB allocation is an Outer RB allocation for other allocations that are not an Inner RB allocation or, when applicable, Edge RB allocation. An RB allocation is regarded as almost contiguous allocation if CP-OFDM allocation satisfies the following conditions: N_{RB_gap}/(N_{RB_alloc}+N_{RB_gap})≤0.25 and N_{RB_alloc}+N_{RB_gap} is larger than 106, 51 or 24 RBs for 15 kHz, 30 kHz or 60 kHz SCS respectively where N_{RB_gap} is the total number of unallocated RBs between allocated RBs and N_{RB_alloc} is the total number of allocated RBs. The size and location of allocated and unallocated RBs are restricted by resource block group (RBG) parameters specified in clause 6.1.2.2 of TS 38.214 v17.3.0. For these almost contiguous signals in power class 2 and 3, the specified MPR values are increased by CEIL{10 log₁₀(1+N_{RB_gap}/N_{RB_alloc}), 0.5} dB, where CEIL{x,0.5} means x rounding upwards to closest 0.5 dB. The parameters of RB_{Start,Low} and RB_{Start,High} to specify valid RB allocation ranges for Outer and Inner RB allocations are defined as RB_{Start,Low}=max(1, floor((N_{RB_alloc}+N_{RB_gap})/2)) and RB_{Start,High}=N_{RB}−RB_{Start,Low}−N_{RB_alloc}−N_{RB_gap}.

P-MPR_{c} is the power management maximum power reduction used for a UE to fulfill the SAR requirements, for example for ensuring compliance with applicable electromagnetic energy absorption requirements and addressing unwanted emissions/self defense requirements in case of simultaneous transmissions on multiple radio access technologies (RATs), or ensuring compliance with applicable electromagnetic energy absorption requirements in case of proximity detection is used to address such requirements that require a lower maximum output power, and it is applied for serving cell c for the cases herein. For UE conducted conformance testing P-MPR_{c} is set to 0 dB. The scope of introducing P-MPRc in the P_{CMAX,f,c} equation is for the UE to report to the gNB information for an available maximum output transmit power. That information can be used by the gNB for scheduling decisions. Thus, P-MPRc may impact the uplink performance/throughput for a UE.

For uplink intra-band CA, the UE sets its configured maximum output power P_{CMAX,c} for serving cell c and its total configured maximum output power P_{CMAX}. The configured maximum output power P_{CMAX,c} on serving cell c is defined herein as by setting MPR_{c}=MPR and A-MPR_{c}=A-MPR with MPR and A-MPR determined for uplink CA operation. Regarding PHR, the following exception applies: if the UE is configured with multiple uplink serving cells, the power P_{CMAX,c} used for the purpose of PH reporting on first serving cell c=c₁ does not take into account for computation of the PH report transmissions on a second serving cell c₂ as exempted in subclause 7.7.1 in TS 38.213 v17.3.0. There is one power management term for the UE, denoted P-MPR, and P-MPR_{c}=P-MPR. A UE sets its total configured maximum output power P_{CMAX} within upper and lower bounds as P_{CMAX_L}≤P_{CMAX}≤P_{CMAX_H}. For uplink intra-band contiguous CA when same slot pattern is used in aggregated serving cells,

$${P}_{CMAX \_ L} = MIN \{ 10 {log}_{10} \sum {p}_{EMAX , c} - Δ {T}_{C} , {P}_{EMAX , CA} , ( {P}_{PowerClass , CA} - Δ {P}_{PowerClass , CA} ) - MAX ( MAX ( MPR , A - MPR ) + Δ {T}_{IB , c} + Δ {T}_{C} + Δ {T}_{RxSRS} , P - {MPR}_{c} ) \} ,$$

$$and$$

$${P}_{CMAX \_ H} = MIN \{ 10 {log}_{10} \sum {p}_{EMAX , c} , {P}_{EMAX , CA} , {P}_{PowerClass , CA} - Δ {P}_{PowerClass , CA} \} .$$

For uplink inter-band CA, the UE sets its configured maximum output power P_{CMAX,c} for serving cell c and its total configured maximum output power P_{CMAX}. The configured maximum output power P_{CMAX,c} on serving cell c is defined herein as, except that the UE power class for serving cell c on the specific operating band is determined by the RRC powerClassPerBand as indicated for the band combination, if signalled. For uplink inter-band carrier aggregation, MPR_{c} and A-MPR_{c} apply per serving cell c. P-MPR_{c} accounts for power management for serving cell c. The UE calculates P_{CMAX,c} under the expectation that the transmit power is increased independently on component carriers. The UE sets its total configured maximum output power P_{CMAX} within upper and lower bounds as P_{CMAX_L}≤P_{CMAX}≤P_{CMAX_H}. For uplink inter-band CA with one serving cell c per operating band and when a same slot symbol pattern is used in aggregated serving cells,

$${P}_{CMAX \_ L} = MIN \{ 10 {log}_{10} \sum MIN [ {p}_{EMAX , c} / ( Δ {t}_{C , c} ) , {p}_{PowerClass , c} / ( MAX ( {mpr}_{c} \cdot Δ {mpr}_{c} , a - mpr ) \cdot Δ {t}_{C , c} \cdot Δ {t}_{IB , c} \cdot Δ {t}_{RxSRS , c} ) , {p}_{PowrClass , c} / {pmpr}_{c} ] , {P}_{EMAX , CA} , {P}_{PowerClass , CA} - Δ {P}_{PowerClass , CA} \} ,$$

$$and$$

$${P}_{CMAX \_H} = MIN \{ 10 {log}_{10} \sum {p}_{EMAX , c} , {P}_{EMAX , CA} , {P}_{PowerClass , CA} - Δ {P}_{PowerClass , CA} \} .$$

A UE can indicate a capability to transmit at a maximum output power that is larger than what the power class for an UL CA/DC configuration allows for single carrier operation. For example, for the UE supporting PC3 (23 dBm) in one band (time division duplexing (TDD) or frequency division duplexing (FDD)) and PC2 (26 dBm) in another band (TDD), the carrier aggregation (CA) configuration can set the maximum transmit power limit according to PC2 (26 dBm) and the maximum composite power from both transmitters would be limited to 26 dBm. With the increased maximum output power capability, the UE is allowed to transmit with the power combined over the two carriers when simultaneously transmitting at maximum power on each carrier. In this example, the maximum allowed power would be the aggregated value of 27.8 dBm. The UE capability is referred to as higherPowerLimit capability, and indicates whether UE supports increase in maximum output power above the power class indication for inter-band UL CA and NR-DC band combinations operating in FR1, FR2 or FR3.

When a UE indicates a higherPowerLimit capability for a CA configuration and ΔP_{PowerClass, CA}=0, the maximum UE power as specified for the UE power class P_{PowerClass,CA} for the calculation of both P_{CMAX_L} and P_{CMAX_H} can be replaced by the sum of the UE power on each carrier as 10 log₁₀Σp_{PowerClass,c}, which is the linear value of the maximum UE power for serving cell c specified in Table 6.2.1-1 of TS 38.101-1 v18.5.0.

Subject to a UE capability and to a network configuration of a reporting, a UE can report ΔP_{PowerClass} and the reporting is triggered by uplink duty cycle exceedance or by return to the power class after the duty cycle exceedance. The UE capability deltaPowerClassReporting indicates whether the UE supports ΔP_{PowerClass}/ΔP_{PowerClass, CA}/ΔP_{PowerClass, EN-DC}/ΔP_{PowerClass, NR-DC} reporting which is triggered upon uplink duty cycle exceedance or upon return to the power class after the duty cycle exceedance, as specified in TS 38.101-1 [2] and TS 38.101-3 [4]. Value type1 indicates the UE can only report ΔP_{PowerClass} for non-CA operation, value type2 indicates the UE can report ΔP_{PowerClass} for non-CA operation, and the UE can also report ΔP_{PowerClass}/ΔP_{PowerClass,CA}/ΔP_{PowerClass,EN-DC}/ΔP_{PowerClass,NR-DC} for CA operation. Thus, the ΔP_{PowerClass}, also referred as DPC, is the adjustment to maximum output power for a given power class for a Serving Cell or for a Band Combination, and a PHR procedure provides the gNB with the DPC when DPC reporting is triggered.

A UE (e.g., the UE 116) in RRC_CONNECTED state can be provided by higher layers a configuration for intra-frequency or inter-frequency measurements of cells. A network (e.g., the network 130) may configure the UE to perform different types of measurements. In one example, the network may configure the UE to report measurement information based on synchronization signal/physical broadcast channel (SS/PBCH) block(s), such as measurement results per SS/PBCH block, measurement results per cell based on SS/PBCH block(s), or SS/PBCH block(s) indexes. In one example, the network may configure the UE to report measurement information based on CSI-RS resources, such as measurement results per CSI-RS resource, measurement results per cell based on CSI-RS resource(s), or CSI-RS resource measurement identifiers. In one example, the network may configure the UE to perform measurements for NR sidelink and vehicle-to-everything (V2X) sidelink, such as CBR measurements. In one example, the network may configure the UE to report cross link interference (CLI) measurement information based on SRS resources, such as measurement results per SRS resource, or SRS resource(s) indexes. In one example, the network may configure the UE to report CLI measurement information based on CLI-received signal strength indicator (RSSI) resources, such as measurement results per CLI-RSSI resource, or CLI-RSSI resource(s) indexes. In one example, the network may configure the UE to report Rx-Tx time difference measurement information based on CSI-RS for tracking or positioning reference signal (PRS), or UE Rx-Tx time difference measurement result.

A measurement configuration includes a reporting configuration associated with one or more objects on which the UE performs measurements. The reporting configuration may include a criterion that triggers the UE to send a measurement report periodically or as a single event; a RS that the UE uses for beam and cell measurement results (e.g., SS/PBCH block or CSI-RS); a reporting format including the quantities per cell and per beam that the UE includes in the measurement report (e.g., RSRP) and other associated information such as the maximum number of cells and the maximum number beams per cell to report; measurement gaps that are time periods the UE may use to perform measurements; measurement windows that are time periods that the UE may use to perform inter-RAT measurements.

FIG. 6 illustrates a signal flow of an example procedure 600 for a conditional handover (CHO) according to embodiments of the present disclosure. For example, procedure 600 can be performed by the UE 116, the BS 102, and the BS 103 in the wireless network 100 of FIG. 1. This example is for illustration only and other embodiments can be used without departing from the scope of the present disclosure.

The procedure begins in 602, a source cell transmits measurement control to a UE. In 604, the UE measurement event is triggered. In 606, the UE transmits a measurement report to the source cell. In 608, the source cell performs a HO decision. In 610, the source cell transmits a HO request to a target cell. In 612, the target cell performs admission control. In 614, the target cell transmits a HO acknowledgement (ACK) to the source cell. In 616, the source cell transmits a RRC reconfig/HO command to the UE. In 618, the UE transmits RRC Reconfig complete to the source cell. In 620, the UE performs CHO condition evaluation. In 622, the UE detaches from the source gNB. In 624, the UE, the source cell, and the target cell complete CHO. In 626, the UE transmits random access to the target cell.

Based on measurement reports from a UE to a gNB, the gNB can prepare a handover (HO) from the current serving cell, i.e., source cell, to a target cell. The HO execution can be triggered by transmitting a HO command in an RRC message (e.g., RRCReconfiguration) or by a MAC CE or by DCI for Layer 1/Layer 2 triggered mobility (LTM).

For HO based on RRC signaling, the gNB can prepare a conditional HO (CHO), with multiple candidate cells for the UE to evaluate, and transmit a CHO configuration in an RRC message (e.g., RRCReconfiguration) to trigger the CHO evaluation. The UE starts evaluating the execution condition(s) upon receiving the CHO configuration, and stops evaluating the execution condition(s) once a handover is executed. An execution condition may include one or multiple trigger condition(s). In one example, for the evaluation of a CHO execution condition of a single candidate cell at most two different trigger quantities can be configured simultaneously. For example, RSRP and RSRQ, or RSRP and SINR, etc. In one example, for the evaluation of a CHO execution condition of a single candidate cell more than two different trigger quantities can be configured simultaneously.

For HO based on MAC CE or DCI signaling, a UE can be indicated, by RRC signaling, indexes of candidate cells and indexes of SS/PBCH blocks or tracking RS (TRS) or CSI-RS resources per candidate cell for the UE to obtain synchronization and measure corresponding L1-RSRPs. A MAC CE or DCI can activate TCI states, provided by RRC signaling, associated with SS/PBCH blocks or TRS/CSI-RS resources of corresponding candidate cells by indicating associated indexes. If the MAC CE or DCI activates TCI states, another MAC CE or DCI can indicate a TCI state from the activated TCI states; otherwise, the MAC CE or DCI can activate and indicate a TCI state provided by RRC signaling. After reception of the MAC CE or DCI, activated TCI states that are not indicated by the MAC CE are deactivated. The UE is provided configurations by RRC signaling for reporting L1-RSRP measurements that include a number of candidate cells and a number of SS/PBCH blocks or TRS/CSI-RS resources per candidate cell from the number of candidate cells.

With reference to FIG. 6, steps of a CHO procedure that uses measurements for triggering (A3 event) is shown, and the A3 event is triggered when the signal strength of a target cell is larger than a dB margin than the signal strength of the source serving cell for a time period. This example is for illustration only and other embodiments can be used without departing from the scope of the present disclosure.

A CHO procedure by RRC can include the following steps. 1) The source gNB configures the UE measurement procedures and the UE reports according to the measurement configuration. 2) The source gNB decides to use CHO. 3) The source gNB requests CHO for one or more candidate cells belonging to one or more candidate gNBs. A CHO request message is sent for each candidate cell. 4) Admission Control may be performed by the target gNB. 5) The candidate gNB(s) sends CHO response (HO REQUEST ACKNOWLEDGE) including configuration of CHO candidate cell(s) to the source gNB. The CHO response message is sent for each candidate cell. 6) The source gNB sends an RRCReconfiguration message to the UE, containing the configuration of CHO candidate cell(s) and CHO execution condition(s). 7) The UE sends an RRCReconfigurationComplete message to the source gNB. 8) The UE maintains connection with the source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronizes to that candidate cell and completes the RRC handover procedure by sending RRCReconfigurationComplete message to the target gNB. The UE releases stored CHO configurations after successful completion of RRC handover procedure.

Existing HO mechanisms evaluate only downlink measurements by a UE, such as L1-RSRP or L3-RSRP, and fail to capture conditions for transmissions by the UE. For example, the UE may experience worse inter-cell interference on a target/candidate cell than on a source/current cell although the UE may also experience favourable conditions for receptions on the target/candidate cell than on the source/current cell, such as a larger RSRP. Then, as coverage is typically limited on the uplink, performing a HO would be detrimental. For example, the UE may have a smaller number of transmitter antennas, such as one transmitter antenna, than receiver antennas, such as four receiver antennas, experience a larger RSRP for receptions from the target/candidate cell than from the source/current cell due to the reception diversity provided by the multiple receiver antennas, and also experience larger blocking for transmissions to the target/candidate cell than to the source/current cell from the single transmitter antenna. Then, HO to the target/candidate cell would result to a worse overall communication link. For example, due to regulatory requirements, such as Specific Absorption Rate (SAR) emissions, the UE may not be able to transmit with the maximum possible power to the target/candidate cell, that is for example a macro-cell, even though the RSRP from the target/candidate cell is larger than the RSRP from the source/current cell, such as a small cell. In general, the conditions that a UE experiences for transmissions can be different than the ones the UE experiences for receptions and also be unknown to a serving base station. It is therefore beneficial for HO purposes for a UE to provide first information for conditions the UE experiences for transmissions to a target/candidate cell and to the source/current cell, in addition to second information for conditions the UE experiences for respective receptions. The first information can be a PHR or an energy headroom report (EHR), as is subsequently described, while the first information can be a L1-RSRP or a L3-RSRP.

A reporting configuration for conditions of uplink transmissions can be associated with reporting quantities or measurements that are related to a UE transmit power or the capability of the UE for transmitting with a certain power over a certain period of time in a cell using a spatial filter that is associated with a beam/RS for receptions. The quantities to be reported by the UE can be indicated by a serving gNB to the UE via RRC signalling, MAC CE, or a DCI format, or can be predetermined in the specifications of the system operation. Quantities or measurements in one or multiple cells can be used by a gNB to prepare a HO procedure and trigger a HO command and/or to determine a new beam/RS (or TCI-state) and indicate the new beam/RS to the UE. The HO command in an RRC message or a MAC CE command or DCI can also include the information of the new beam/RS that can be used by the UE for the initial transmission in a target cell. In the following, the terms “beam”, “TCI state”, and “RS” are interchangeably used.

Therefore, embodiments of the present disclosure recognize that there is a need to determine quantities related to a UE transmit power for an HO procedure. Embodiments of the present disclosure further recognize that there is another need to define a procedure for HO based on the quantities. Embodiments of the present disclosure further recognize that there is also another need to define the signalling for providing the quantities.

In the following descriptions, each of the quantities or measurements associated with one or multiple cells and with one or multiple beams/RSs per cell can be used alone or in combination, for a gNB to determine whether to trigger a HO command and/or to indicate a new beam/RS, and for a UE to determine whether to report one or more quantities to trigger a HO procedure and/or a beam/RS change and to report one or more quantities.

In a first approach, a reporting configuration is associated with a power headroom report (PHR). A UE provides PHR information associated with a source cell and with a target cell and for corresponding reference signals (RSs), such as SS/PBCH blocks and/or TRS/CSI-RS resources, associated with RSRPs that are coupled to the PHRs. Based on the PHR information and on the corresponding RSRP values, a gNB can determine whether to initiate a HO procedure (via RRC or MAC CE or DCI). Reporting of the PHRs, and of the RSRPs coupled to the PHRs, may then trigger the HO procedure. Therefore, when a UE is provided indexes/identities of candidate cells and indexes of RSs to determine respective L1-RSRPs or L3-RSRPs per candidate cells for HO, the UE provides indexes of candidate cells, the L1-RSRPs or L3-RSRPs and the indexes of the RSs associated with each index of the candidate cells, and additionally provides PHRs corresponding to transmissions with spatial filters associated with TCI states of the RSs. In case there is only one RS for a candidate cell, the PHR corresponds to transmissions by the UE on the candidate cell. A serving gNB can indicate to the UE to provide the information herein by RRC or MAC CE or DCI. When the indication is by a DCI, the DCI or another DCI can schedule a transmission of a channel where the UE provides indexes of candidate cells for HO, RSRPs and respective RS indexes per such candidate cell, and PHRs corresponding to each of the RS indexes or, in case of a single RS index for candidate cells, corresponding to the candidate cells.

A UE can provide a PHR that indicates the amount of transmit power available for the UE to use. For the source/current cell, the PHR can be an actual PHR or a virtual PHR. For a target/candidate cell, the PHR can be a virtual PHR. The actual PHR can be in addition to the power being used by a certain transmission that can be a reference transmission according to higher layer signalling, an actual transmission dynamically scheduled or semi-statically configured. The virtual PHR can be for a reference/virtual transmission. The virtual transmission is a transmission that differs from an actual transmission or from a reference transmission in one or more parameters (e.g., transform precoder, modulation, MCS). The following descriptions for the PHR equally apply to reference transmissions, actual transmissions and virtual transmissions.

The UE can determine a Type 1 UE power headroom report (PHR) that is valid for a PUSCH transmission occasion i on active UL BWP b of carrier f of serving cell c, based on a reference transmission or format according to higher layer signalling. For a PUSCH transmission in a PUSCH transmission occasion i on active UL BWP b of carrier f of serving cell c, the UE computes the Type 1 power headroom report as

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

$$where {P}_{CMAX , f , c} ( i ) , {P}_{O \_ PUSCH , b , f , c} ( j ) , {M}_{RB , b , f , c}^{PUSCH} ( i ) , {α}_{b , f , c} ( j ) , {PL}_{b , f , c} ( {q}_{d} ) ,$$

$${Δ}_{TF , b , f , c} ( i ) and {f}_{b , f , c} ( i , l ) are defined in clause 7.1 \text{.1} of TS 38.213 .$$

When the UE is indicated a TCI-state k for the PUSCH transmission occasion i on active UL BWP b of carrier f of serving cell c, the UE computes the Type 1 power headroom report associated with TCI-State k (or beam k) as

$${PH}_{type 1 , b , f , c , k} ( i , j , {q}_{d} , l ) = {P}_{CMAX , f , c , k} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

$$where {P}_{CMAX , f , c , k} ( i ) is defined in clause 7.1 \text{.1} of TS 38.213 .$$

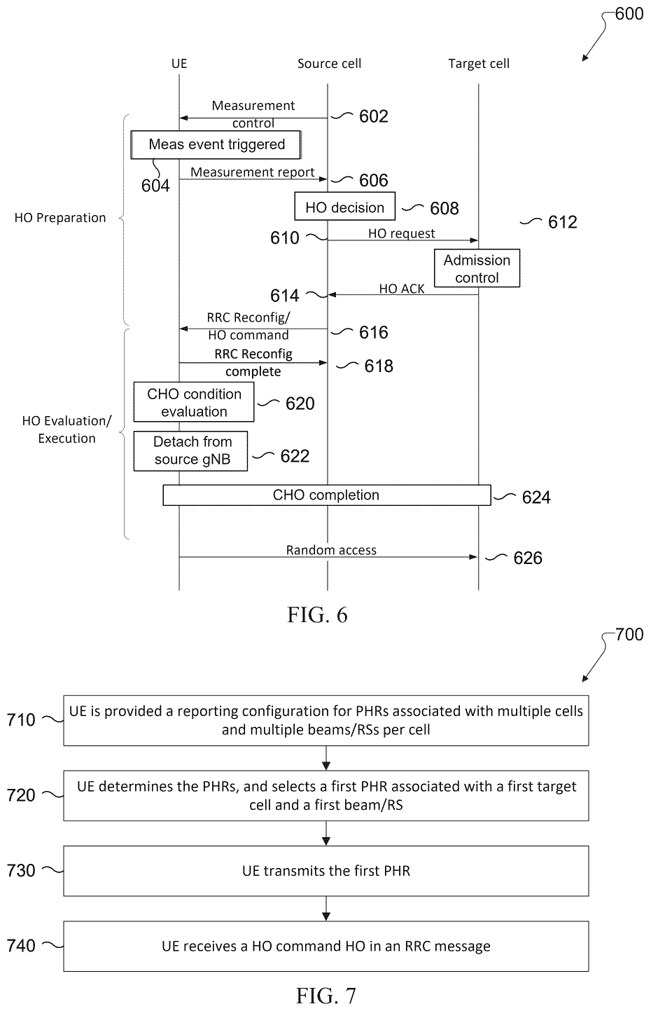

FIG. 7 illustrates a flowchart of an example UE procedure 700 for transmitting PHRs according to embodiments of the present disclosure. For example, procedure 700 can be performed by any of the UEs 111-116 of FIG. 1. This example is for illustration only and other embodiments can be used without departing from the scope of the present disclosure.

A UE is provided a reporting configuration for PHRs associated with multiple cells and multiple beams/RSs per cell 710. The UE determines the PHRs, and selects a first PHR associated with a first target cell and a first beam/RS 720. The UE transmits the first PHR 730. The UE receives a HO command in an RRC message 740. The UE can also transmit a first RSRP associated with the first target cell and the first beam/RS, and also transmit same information for a current serving cell and beam/RS.

In one example the UE provides a first PHR associated with a PUSCH transmission occasion i for a first cell c₁, and a second PHR associated with a PUSCH transmission occasion j for a second cell c₂.

In one example the UE provides a first PHR associated with a PUSCH transmission occasion i for a first cell c₁ and a first TCI state/RS, and a second PHR associated with a PUSCH transmission occasion j according to a reporting configuration, with a second cell c₂ and a second TCI state/RS, wherein the transmission occasion j can be same as or different from transmission occasion i, wherein the first PHR has the largest value among the PHRs associated with TCI states for the first cell c₁ and the second PHR has the largest value among the PHRs associated with TCI-states for the second cell c₁.

In one example the UE provides, in addition to RSRP values of respective RSs, a first PHR associated with a source cell c₁, and a second PHR associated with a target cell c₂ when the second PHR is larger than the first PHR by a configured value Δ.

According to a first configuration, the UE provides the first PHR and the second PHR periodically with a same or different periodicity, using a same MAC CE including the first PHR and the second PHR, or using a first MAC CE including the first PHR and a second MAC CE including the second PHR. A 1-bit signalling in the MAC CE including the first PHR associated with the source cell is used to indicate whether the second PHR associated with the target cell is present. According to a second configuration, the UE provides the first PHR and the second PHR, together with respective first RSRP and second RSRP for the source/current cell and the target/candidate cell, when the UE is provided such indication via RRC, MAC CE, or DCI.

In one example the UE provides a first PHR associated with a source cell c₁, and provides an indication of the first PHR being smaller or larger than a second PHR associated with a target cell c₂. For example, a field of 1-bit in the PHR MAC CE is used for the indication, with a value 0 indicating the PHR of the source cell is larger than the PHR of the target cell (of a configured value Δ), and a value 1 indicating that the PHR of the source cell is smaller than the PHR of the target cell (of a configured value Δ), or vice versa. For example, a field of 2 bits in the PHR MAC CE is used to indicate if the first PHR is larger or smaller (of a configured value Δ) than, or same (within a configured value Δ) as, the second PHR, with a value “00” indicating that first PHR and second PHR are the same, and value “11” being reserved.

In one example the UE is configured with N candidate target cells, with N≥1, and provides an indication of the first PHR associated with the source cell being smaller or larger than the PHR associated with a cell from the N target/candidate cells. For example, a field of N bits in a MAC CE can be used for the indication, wherein each of the N bits is associated with a corresponding target/candidate cell.

In one example the UE is configured with N candidate target cells, with N≥1, and reports a differential value D that can be obtained as the difference between a first PHR associate with the source cell and a second PHR associated with a candidate target cell.

In one example the UE provides a first PHR associated with a source cell c₁, and provides a second PHR associated with a target cell c₂ if the second PHR is larger than the first PHR of a configured value Δ. According to a configuration, the UE provides the first PHR and the second PHR periodically with a same or different periodicity, using a same MAC CE including the first PHR and the second PHR, or using a first MAC CE including the first PHR and a second MAC CE including the second PHR. A 1-bit signalling in the MAC CE including the first PHR associated with the source cell is used to indicate whether the second PHR associated with the target cell is present.

In one example the UE provides a first PHR associated with a source cell c₁, and provides an indication of the first PHR being smaller or larger than a second PHR associated with a target cell c₂. For example, a field of 1-bit in the PHR MAC CE is used for the indication, with a value 0 indicating the PHR of the source cell is larger than the PHR of the target cell (of a configured value Δ), and a value 1 indicating that the PHR of the source cell is smaller than the PHR of the target cell (of a configured value Δ), or vice versa. For example, a field of 2 bits in the PHR MAC CE is used to indicate if the first PHR is larger or smaller (of a configured value Δ) than, or same (within a configured value Δ) as, the second PHR, with a value “00” indicating that first PHR and second PHR are the same, and value “11” being reserved.

In one example the UE is configured with N candidate target cells, with N≥1, and provides an indication of the first PHR associated with the source cell being smaller or larger than the PHR associated with a cell from the N target cells. A field of N bits in a MAC CE can be used for the indication, wherein each of the N bits is associated with a corresponding target cell.

In one example the UE is configured with N candidate target cells, with N≥1, and reports a differential value D that can be obtained as the difference between a first PHR associate with the source cell and a second PHR associated with a candidate target cell. The differential value D can be reported at a same or different time instance of the reporting of the PHR of the source cell with a same or different periodicity according to a higher layer configuration. The report of the differential value D is triggered by MAC CE or DCI. The differential value D is reported when it exceeds a configured value, and when it is reported, a 1-bit signalling in the MAC CE including the PHR of the source cell is used to indicate whether the report of the differential value D is present in the MAC CE. For example, a DCI can indicate to the UE to provide a number of RSRP values and PHR values, a corresponding index of an RS and a corresponding index of a candidate cell for each RSRP/PHR value. For example, the DCI can include a field indicating whether or not the UE provides the information mentioned herein. For example, the DCI can additionally schedule a channel for the UE to provide the information mentioned herein. For example, the number of RSRP/PHR values can be configured in advance by RRC signalling or can be indicated by the DCI.

With reference to FIG. 7, an example procedure is shown for a UE to transmit multiple PHRs associated with corresponding multiple cells and multiple beams per cell, and to monitor for reception of a HO command according to the disclosure.

In a second approach, a reporting configuration is associated with a UE power available over a time period. That is equivalent to an energy the UE can use over the time period. In the following it is referred as the energy report or the energy headroom report (EHR). The UE provides EHR information associated with a source cell and with a target cell, and based on the EHR information a gNB determines whether to initiate a HO procedure (via RRC or MAC CE or DCI). Reporting of the EHR may then trigger the HO procedure. Similar principles as for reporting PHR can apply when the UE reports EHR. An association of an EHR with an RSRP is not explicitly stated for conciseness.

For example, the UE can report how much power the UE has available for a time period, for example over the next 40 ms, 80 ms, or 160 ms, using a UE configuration. For example, the UE can report such energy information associated with a power class. For example, the UE with higherPowerLimit capability and configured with carrier aggregation operation, can indicate whether the energy report is determined using the larger UE power class among the configured power class for each component carrier or using the aggregated power over the carriers, and the number of carriers can be two or more. The UE determines the energy report over an evaluation period that can be configured by the gNB, for example the gNB indicates a value of the estimation period among multiple possible values, or determined by the UE, and is subject to regulatory emission limits.

In one example the UE provides a first energy report (HER) associated with a PUSCH transmission occasion i for a first cell c₁, and a second EHR associated with a PUSCH transmission occasion j for a second cell c₂. The UE can provide the first and second energy reports in addition to first and second RSRP measurements associated with the first and second cells.

In one example the UE provides a first energy report associated with a PUSCH transmission occasion i for a first cell c₁ and a first TCI state/RS, and a second energy report associated with a PUSCH transmission occasion j according to a reporting configuration, with a second cell c₂ and a second TCI state/RS, wherein the transmission occasion j can be same as or different from transmission occasion i, wherein the first energy report has the largest value among the energy reports associated with TCI states/RSs for the first cell c₁ and the second energy report has the largest value among the energy reports associated with TCI states/RSs for the second cell c₂.

In one example the UE provides a first EHR associated with a source cell c₁, and provides a second EHR associated with a target cell c₂ if the second EHR is larger than the first energy report of a configured value Δ. According to a configuration, the UE provides the first EHR and the second EHR periodically with a same or different periodicity, using a same MAC CE including the first EHR and the second EHR, or using a first MAC CE including the first EHR and a second MAC CE including the second EHR. A 1-bit signalling in the MAC CE including the first EHR associated with the source cell is used to indicate whether the second EHR associated with the target cell is present.

In one example the UE provides a first EHR associated with a source cell c₁, and provides an indication of the first EHR being smaller or larger than a second EHR associated with a target cell c₂. For example, a field of 1-bit in the EHR MAC CE is used for the indication, with a value 0 indicating the EHR of the source cell is larger than the EHR of the target cell (of a configured value Δ), and a value 1 indicating that the EHR of the source cell is smaller than the EHR of the target cell (of a configured value Δ), or vice versa. For example, a field of 2 bits in the EHR MAC CE is used to indicate if the first EHR is larger or smaller (of a configured value Δ) than, or same (within a configured value Δ) as, the second EHR, with a value “00” indicating that first EHR and second EHR are the same, and value “11” being reserved.

In one example the UE is configured with N candidate target cells, with N≥1, and provides an indication of the first EHR associated with the source cell being smaller or larger than the EHR associated with a cell from the N target cells. A field of N bits in a MAC CE can be used for the indication, wherein each of the N bits is associated with a corresponding target cell.

In one example the UE is configured with N candidate target cells, with N≥1, and reports a differential value D that can be obtained as the difference between a first EHR associated with the source cell and a second EHR associated with a candidate target cell. The differential value D can be reported at a same or different time instance of the reporting of the EHR of the source cell with a same or different periodicity according to a higher layer configuration. The report of the differential value D is triggered by MAC CE. The differential value D is reported when it exceeds a configured value, and when it is reported, a 1-bit signalling in the MAC CE including the energy report of the source cell is used to indicate whether the report of the differential value D is present in the MAC CE.

FIG. 8 illustrates timelines 800 for transmit power estimation and power level support according to embodiments of the present disclosure. For example, timelines 800 can be followed by the UE 116 of FIG. 3. This example is for illustration only and other embodiments can be used without departing from the scope of the present disclosure.

With reference to FIG. 8, an example is shown of an evaluation period over which the UE estimates an average transmit power subject to a maximum value, a transmission time interval over which the UE can support a corresponding power level, with power level P1 associated to the interval T1 and power level P2 associated with the interval T2.

A measurement configuration for an EHR can include one or more parameters. In one example, the measurement configuration includes information of the length of the time period that is associated with the EHR and, if multiple EHRs are configured, of the lengths of the time periods. In one example the measurement configuration includes information of the length of the evaluation period used by the UE to estimate the EHR. Alternatively, the evaluation period can be reported by the UE.

In one example, for higherPowerLimit UEs, the measurement configuration can include information on whether the EHR should be determined by the UE assuming a transmit power using the larger power class or an aggregated transmit power over the component carriers, and the number of carriers can be two or more.

In one example, for higherPowerLimit UEs, the measurement configuration includes information of one EHR associated with the UE transmit power using the larger power class and another EHR associated with the UE transmit power using the aggregated transmit power over the component carriers.

A reporting configuration can include a periodicity for the UE to provide the EHR, and the UE provides the EHR according to the reporting configuration. In one example the UE provides EHRs during a time interval associated with a timer, and when the timer expires, the UE stops providing the EHRs. In one example the UE provides an EHR only when a condition is satisfied, and the condition can be one or a combination of the following: the EHR associated with a configured or reported time period is above a configured threshold, or the EHR is larger or smaller than a previously reported EHR of a value Δ, the length of the time period over which the UE can transmit at a certain power is larger than a configured time period value.

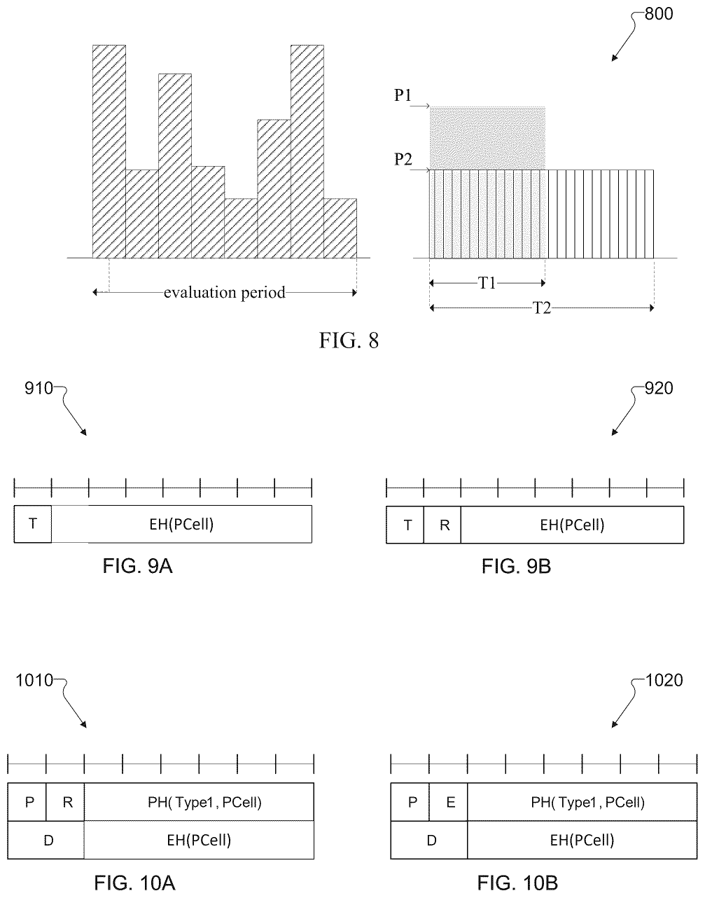

FIGS. 9A and 9B illustrate diagrams of example of MAC CEs 910 and 920 according to embodiments of the present disclosure. For example, MAC CEs 910 and 920 can be transmitted by any of the UEs 111-116 of FIG. 1, such as the UE 111. This example is for illustration only and other embodiments can be used without departing from the scope of the present disclosure.

FIGS. 10A and 10B illustrate diagrams of example of MAC CEs 1010 and 1020 according to embodiments of the present disclosure. For example, MAC CEs 1010 and 1020 can be transmitted by any of the UEs 111-116 of FIG. 1, such as the UE 112. This example is for illustration only and other embodiments can be used without departing from the scope of the present disclosure.

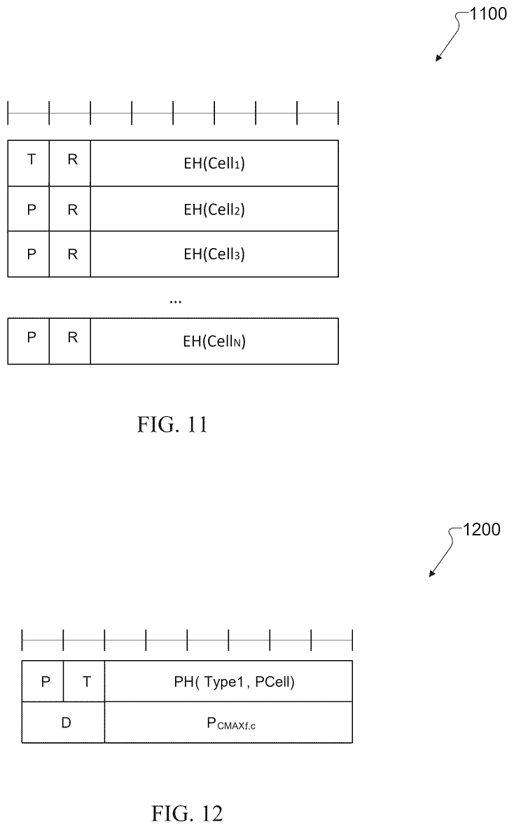

FIG. 11 illustrates a diagram of an example MAC CE 1100 according to embodiments of the present disclosure. For example, MAC CE 1100 can be transmitted by any of the UEs 111-116 of FIG. 1, such as the UE 113. This example is for illustration only and other embodiments can be used without departing from the scope of the present disclosure.

FIG. 12 illustrates a diagram of an example MAC CE 1200 according to embodiments of the present disclosure. For example, MAC CE 1200 can be transmitted by any of the UEs 111-116 of FIG. 1, such as the UE 114. This example is for illustration only and other embodiments can be used without departing from the scope of the present disclosure.

An EHR can be provided via RRC or MAC CE or DCI signalling. The EHR can be provided for the source cell, or for the source cell and the candidate target cells, or only for the candidate target cells.

The EHR can be transmitted in a MAC CE that is identified by a MAC subheader with a corresponding LCID, and has a fixed size.

In one example, as illustrated in FIG. 9A, it includes one octet, and includes
a field T: 1 bit to indicate the length of the time period associated with the EHR, (e.g., value 0 indicates a first length and value 1 indicates a second length, value 0 indicates a length above a configured value T and value 1 indicates a length below T),
a field Energy Headroom (EH): 7 bits to indicate the EHR associated with the time T.

In one example, as illustrated in FIG. 9B, it includes one octet, and includes
a reserved field R: 1 bit;
a field T: 1 bit to indicate the length of the time period associated with the EH report, (e.g., value 0 indicates a first length and value 1 indicates a second length, value 0 indicates a length above a configured value T and value 1 indicates a length below T),
a field Energy Headroom (EH): 6 bits to indicate the EH report associated with the time T.

In one example, as illustrated in FIGS. 10A and 10B, the EHR is reported in a same MAC CE as the Power Headroom (PH) report, and the MAC CE may (as in FIG. 10B) or may not (as in FIG. 10A) include a bit that indicates whether the EHR is present, e.g., a field E. The MAC CE may also indicate the time associated with the EHR in a field T (as shown in FIG. 11).

In one example, as illustrated in FIG. 11, the EH is reported for the source and for a number of target cell, and a field T to indicate the length of the time period is present for the EH of each cell. Alternatively, the time information is only present for the source cell, and it is expected to be the same for the EHs of source and target cells.

In one example, as illustrated in FIG. 12, the UE indicates the PHR in the MAC CE and a time information associated with PHR in a field of 1 or 2 bits.

In a third approach, a reporting configuration is associated with a DPC report, wherein the DPC report can be ΔP_{PowerClass}/ΔP_{PowerClass, CA}/ΔP_{PowerClass, EN-DC}/ΔP_{PowerClass, NR-DC} report depending on whether the UE is configured to operate with single carrier/CA/EN-DC/NR-DC, respectively. The UE provides DPC information, and based on the DPC information a gNB determines whether to initiate a HO procedure. Reporting of the DPC may then trigger the HO procedure.

The UE may transmit the DPC report periodically or in response to an indication by a gNB, wherein the indication can be via RRC signaling or in a MAC CE or in a DCI format. The DPC report may also be triggered upon uplink duty cycle exceedance or upon return to the power class after the duty cycle exceedance.

In a fourth approach, a reporting configuration is associated with an indication of a duty cycle exceedance. The maximum duty cycle is associated to a UE power class and indicates the maximum percentage of uplink symbols that can be transmitted in a certain evaluation period using the indicated power class in order to meet SAR requirements. The UE can indicate when an uplink duty cycle exceedance occurs or provide a duty cycle report when the uplink duty cycle exceedance occurs. Based on the information related to the duty cycle, a gNB (e.g., the BS 102) determines whether to initiate a HO procedure. The indication of the duty cycle exceedance or the duty cycle report when the duty cycle exceedance occurs may then trigger the HO procedure.

In a fifth approach, a reporting configuration is associated with a UE power class. For example, a higherPowerLimit UE that can transmit using the transmit power of the higher power class or the aggregated power over the component carriers, can report when the transmit power of the higher power class is used and when the aggregated power over the component carriers is used. The UE can also report an information associated with a percentage of time that the UE transmits with the power of the higher power class or associated with a percentage of time that the UE transmits with the aggregated power over the component carriers, and the evaluation period over which the UE calculates the percentage of time can be provided in a measurement configuration. Based on the information related to the UE power class being used, a gNB determines whether to initiate a HO procedure. The indication of the UE power class being used may then trigger the HO procedure.

In a sixth approach, a reporting configuration is associated with a P_{CMAX,f,c}(i) value. The UE reports P_{CMAX,f,c}(i) values, and the P_{CMAX,f,c}(i) values can be reported in a same MAC CE that includes PH reports or EH reports. Based on the information of P_{CMAX,f,c}(i), a gNB determines whether to initiate a HO procedure. The indication of P_{CMAX,f,c}(i) may then trigger the HO procedure. The UE can report a P_{CMAX,f,c}(i) value for a cell or can report a P_{CMAX,f,c,k}(i) value for a beam.

A UE can report one or more of the described quantities herein that are related to a UE transmit power and its capability of transmitting with a certain power over a time period after receiving an indication from a gNB on a source cell via RRC signalling, or in a MAC CE or in a DCI format.

In one example the UE receives a reporting configuration that includes a reporting format including the quantities per cell and per beam that the UE includes in the measurement report (e.g., energy report) and other associated information such as the maximum number of cells and the maximum number beams per cell to report; and measurement gaps that are time periods the UE may use to perform measurements.

In one example the UE receives information for one or more search space sets for receiving PDCCHs and a PDCCH provides a DCI format that schedules a PDSCH including an indication triggering the measurement report or a PUSCH including an indication triggering the measurement report and/or including the measurement report.

In one example, the UE receives information for one or more search space sets for receiving PDCCHs and a PDCCH provides a DCI format that includes an indication to start transmitting the measurement report, determines a resource for the transmission of the measurement report and transmits the measurement report using the resource, or transmits the measurement report periodically according to a configuration and stops transmitting the measurement report after a time interval associate with a timer or until the UE receives an indication in a DCI format to stop transmitting or when the UE receives an HO command HO command in an RRC message (e.g., RRCReconfiguration).

When the UE is configured for measurement reports associated with N target/candidate cells and a source/current serving cell, the UE determines M>=N measurement reports based on the one or more RSs for each of the N cells and may transmit K<=M measurement reports. The values of N and M can be determined based on the configuration of a set of candidate cells and a set of RSs per candidate cell and K can be previously indicated by RRC signalling or by a MAC CE or DCI triggering the measurement report. For example, for a measurement report including one RS for one candidate cell, the UE can transmit a first measurement report associated with a source cell and a second measurement report associated with a cell from the target/candidate cells (K=2). The UE includes the index of the candidate cell and the index of the RS for the candidate cell, for example when the set of candidate cells includes more than one cell and a candidate cell includes more than one RS, respectively. For example, the measurement report is an EHR, and the UE transmits the largest EHR or the EHR with the largest time period T.

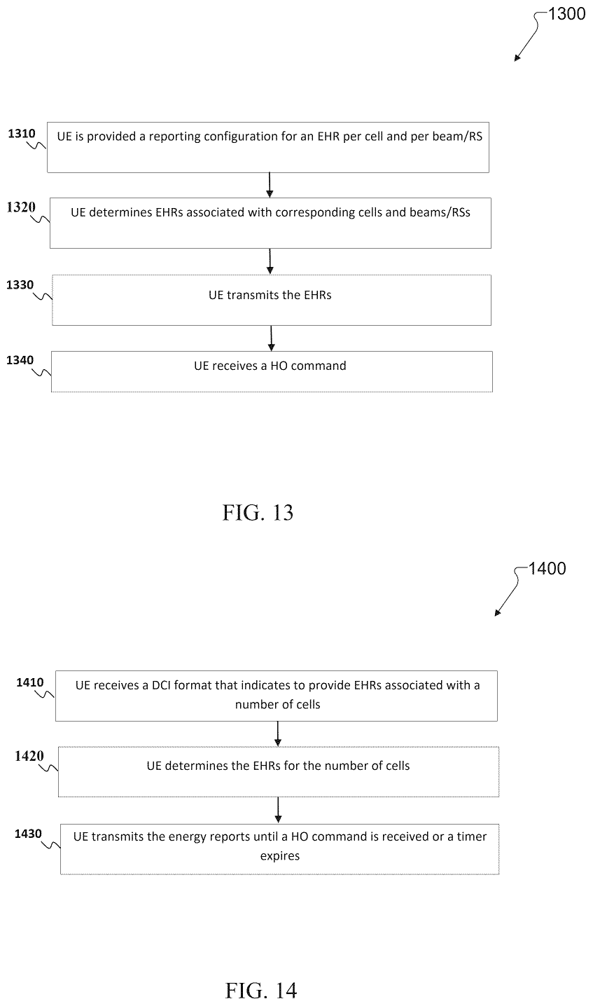

FIG. 13 illustrates a flowchart of an example UE procedure 1300 for transmitting an energy report and receiving a HO command according to embodiments of the present disclosure. For example, procedure 1300 can be performed by any of the UEs 111-116 of FIG. 1, such as the UE 115. This example is for illustration only and other embodiments can be used without departing from the scope of the present disclosure.

A UE is provided a reporting configuration for an EHR per cell and per beam/RS 1310. The determines EHRs associated with corresponding cells and beams/RSs 1320. The UE transmits the EHRs 1330. The UE receives a HO command HO via an RRC message, a MAC CE, or a DCI 1340.

With reference to FIG. 13, an example procedure is shown for a UE to transmit an EHR and to monitor for reception of a HO command according to the disclosure.

FIG. 14 illustrates a flowchart of an example UE procedure 1400 for transmitting an energy report according to embodiments of the present disclosure. For example, procedure 1400 can be performed by any of the UEs 111-116 of FIG. 1, such as the UE 116. This example is for illustration only and other embodiments can be used without departing from the scope of the present disclosure.

A UE receives a DCI format that indicates to the UE to provide EHRs associated with a number of candidate cells and a source cell 1410. The UE determines the EHRs for the number of cells 1420. The UE transmits the EHRs until a HO command is received or a timer expires 1430.

With reference to FIG. 14, an example procedure is shown for a UE to transmit EHRs associated with a number of cells in response to a DCI format according to the disclosure.

A UE may initiate a HO procedure by reporting one or more of the described quantities herein when provided a configuration of a reporting format including the quantities per cell and/or per beam/RS that the UE includes in the measurement report (e.g., EHR), of other associated information such as the maximum number of cells and the maximum number beams/RS per cell to report, and of measurement gaps that are time periods the UE may use to perform measurements. The UE determines whether to transmit EHRs associated to a number of cells and/or beams/RSs based on a one or more conditions, and transmits the EHRs when the one or more conditions are met.

In one example the UE transmits/provides an EHR when the EHR exceeds a threshold that can be configured by the gNB or determined by the UE.

In one example the UE determines EHRs for a number of cells and transmits a first EHR for the source cell and a second EHR, together with a cell identity/index and an RS index, when applicable, wherein the second EHR is the largest EHR among the EHRs for the target cells, and the second EHR is above a threshold that can be configured by the gNB or determined by the UE.

In one example the UE determines EHRs for a number of cells and beams/RSs, and transmits a first EHR associated with the source cell and with a first beam/RS, and a second EHR, wherein the second EHR is the largest EHR among the EHRs associated with the target cells and beams/RSs, and the second EHR is above a threshold that can be configured by the gNB or determined by the UE. Additionally, or alternatively, the UE indicates the target cell and the beam/RS that are associated with the second EHR. In one example, the UE provides a first index to indicate the target cell and a second index to indicate the beam/RS. In one example the UE provides an index to indicate the beam/RS, and a mapping between first indexes associated with cells and second indexes associated with beams/RSs exists.

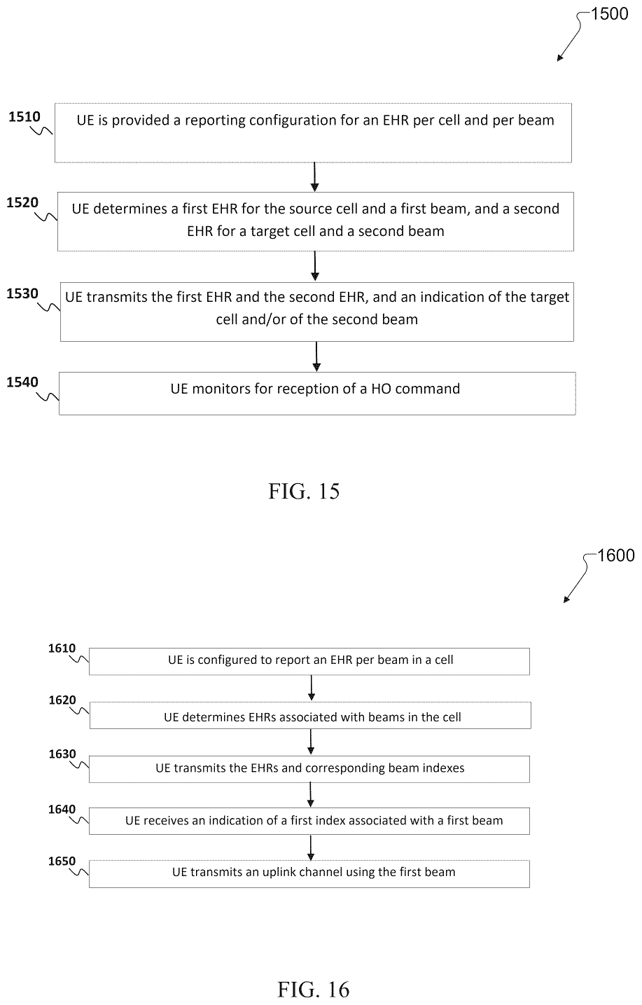

FIG. 15 illustrates a flowchart of an example UE procedure 1500 for receiving a HO command according to embodiments of the present disclosure. For example, procedure 1500 can be performed by the UE 116 of FIG. 3. This example is for illustration only and other embodiments can be used without departing from the scope of the present disclosure.

A UE is provided a reporting configuration for an EHR per cell and per beam/RS 1510. The UE determines a first EHR for the source cell and a first beam/RS, and a second EHR for a target cell and a second beam/RS 1520. The UE transmits the first EHR and the second EHR, and an indication of the target cell and/or of the second beam/RS 1530. The UE monitors for reception of a HO command HO in an RRC message, MAC CE, or DCI 1540.

With reference to FIG. 15, an example procedure is shown for a UE to initiate a HO procedure according to the disclosure.

For operation with a single cell and multiple beams/RSs, a UE can be configured to report, per beam/RS, one or more of the described quantities herein that are related to a UE transmit power and its capability of transmitting with a certain power over a time period, after receiving an indication from a gNB via RRC signalling, or MAC CE, or DCI format, or based on whether a condition is satisfied. For example, the UE transmits an EHR associated with a beam/RS that is above a threshold, and among multiple EHRs associated with multiple beams/RSs, the UE selects the largest EHR to be reported. The UE may also indicate an index associated with the beam/RS.

FIG. 16 illustrates a flowchart of an example UE procedure 1600 for providing an energy report associated with a beam according to embodiments of the present disclosure. For example, procedure 1600 can be performed by any of the UEs 111-116 of FIG. 1. This example is for illustration only and other embodiments can be used without departing from the scope of the present disclosure.

A UE is configured to report an EHR per beam/RS in a cell 1610. The UE determines EHRs associated with beams in the cell 1620. The UE transmits the energy reports and corresponding beam/RS indexes 1630. The UE receives an indication of a first index associated with a first beam/RS 1640. The UE transmits an uplink channel using the first beam/RS 1650.

With reference to FIG. 16, an example procedure is shown for a UE to provide an EHR associated with a beam/RS according to the disclosure. The example procedure equally applies when the UE report a PHR or other quantities described herein per beam/RS.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information for a set of candidate cells, wherein each candidate cell from the set of candidate cells is identified by a corresponding candidate cell index;
receiving second information for a set of reference signals (RSs), wherein:
one or more RSs from the set of RSs are associated with one candidate cell from the set of candidate cells, and
a RS for a candidate cell is identified by a corresponding RS index;
receiving a first RS from a first candidate cell;
receiving a second RS from a serving cell;
determining a first reference signal received power (RSRP) for the first RS;
determining a second RSRP for the second RS;
determining a first power headroom report (PHR), wherein the first PHR is associated with a transmission on the first candidate cell;
determining a second PHR, wherein the second PHR is associated with a transmission on the serving cell; and
transmitting a channel with the first RSRP, the second RSRP, the first PHR, and the second PHR.

2. The method of claim 1, wherein the first PHR is associated with a first virtual transmission and the second PHR is associated with a second virtual transmission.

3. The method of claim 1, wherein the first PHR is associated with a first virtual transmission and the second PHR is associated with a second actual transmission.

4. The method of claim 1, wherein:
a value of the second PHR is an actual value, and
a value of the first PHR is a differential value relative to the value of the second PHR.

5. The method of claim 1, further comprising:
receiving a physical downlink control channel (PDCCH), wherein:
the PDCCH provides a downlink control information (DCI) format, and
the DCI format indicates the determination of the first RSRP and of the first PHR.

6. The method of claim 1, further comprising:
receiving a physical downlink control channel (PDCCH), wherein:
the PDCCH provides a downlink control information (DCI) format, and
the DCI format indicates the transmission of the channel with the first RSRP, the second RSRP, the first PHR, and the second PHR.

7. The method of claim 1, further comprising:
receiving a physical downlink control channel (PDCCH) on a first cell, wherein:
the PDCCH provides a downlink control information (DCI) format, and
the DCI format provides a handover command to a second cell.

8. A user equipment (UE) comprising:
a transceiver configured to receive:
first information for a set of candidate cells, wherein each candidate cell from the set of candidate cells is identified by a corresponding candidate cell index,
second information for a set of reference signals (RSs), wherein:
one or more RSs from the set of RSs are associated with one candidate cell from the set of candidate cells, and
a RS for a candidate cell is identified by a corresponding RS index,
a first RS from a first candidate cell, and
a second RS from a serving cell; and
a processor operably coupled to the transceiver, the processor configured to determine:
a first reference signal received power (RSRP) for the first RS,
a second RSRP for the second RS,
a first power headroom report (PHR), wherein the first PHR is associated with a transmission on the first candidate cell, and
a second PHR, wherein the second PHR is associated with a transmission on the serving cell,
wherein the transceiver is further configured to transmit a channel with the first RSRP, the second RSRP, the first PHR, and the second PHR.

9. The UE of claim 8, wherein the first PHR is associated with a first virtual transmission and the second PHR is associated with a second virtual transmission.

10. The UE of claim 8, wherein the first PHR is associated with a first virtual transmission and the second PHR is associated with a second actual transmission.

11. The UE of claim 8, wherein:
a value of the second PHR is an actual value, and
a value of the first PHR is a differential value relative to the value of the second PHR.

12. The UE of claim 8, wherein:
the transceiver is further configured to receive a physical downlink control channel (PDCCH),
the PDCCH provides a downlink control information (DCI) format, and
the DCI format indicates the determination of the first RSRP and of the first PHR.

13. The UE of claim 8, wherein:
the transceiver is further configured to receive a physical downlink control channel (PDCCH),
the PDCCH provides a downlink control information (DCI) format, and
the DCI format indicates the transmission of the channel with the first RSRP, the second RSRP, the first PHR, and the second PHR.

14. The UE of claim 8, wherein:
the transceiver is further configured to receive a physical downlink control channel (PDCCH),
the PDCCH provides a downlink control information (DCI) format, and
the DCI format provides a handover command to a second cell.

15. A base station (BS) comprising:
a transceiver configured to:
transmit:
first information for a set of candidate cells, wherein each candidate cell from the set of candidate cells is identified by a corresponding candidate cell index,
second information for a set of reference signals (RSs), wherein:
one or more RSs from the set of RSs are associated with one candidate cell from the set of candidate cells, and
a RS for a candidate cell is identified by a corresponding RS index,
a first RS from a first candidate cell, and
a second RS from a serving cell; and
receive a channel with a first reference signal received power (RSRP), a second RSRP, a first power headroom report (PHR), and a second PHR; and
a processor operably coupled to the transceiver, the processor configured to determine:
an index of a candidate cell associated with the first RSRP, and
an index of an RS associated with the first RSRP and with the first PHR.

16. The BS of claim 15, wherein the first PHR is associated with a first virtual reception and the second PHR is associated with a second virtual reception.

17. The BS of claim 15, wherein the first PHR is associated with a first virtual reception and the second PHR is associated with a second actual reception.

18. The BS of claim 15, wherein:
a value of the second PHR is an actual value, and
a value of the first PHR is a differential value relative to the value of the second PHR.

19. The BS of claim 15, wherein:
the transceiver is further configured to transmit a physical downlink control channel (PDCCH),
the PDCCH provides a downlink control information (DCI) format, and
the DCI format indicates the reception of the channel with the first RSRP, the second RSRP, the first PHR, and the second PHR.

20. The BS of claim 15, wherein:
the transceiver is further configured to transmit a physical downlink control channel (PDCCH),
the PDCCH provides a downlink control information (DCI) format, and
the DCI format provides a handover command to a second cell.
